(19) United States
(12) Patent Application Publication
(10) Pub. No.: US 2025/0353680 A1
(43) Pub. Date: Nov. 20, 2025

(54) AUTONOMOUSLY MOBILE DEVICE FOR LOADING BOBBINS IN A MANUFACTURING FACILITY

(71) Applicant: COMPAGNIE GENERALE DES ETABLISSEMENTS MICHELIN, Clermont-Ferrand (FR)

(72) Inventors: CEDRIC ASTIER, Clermont-Ferrand (FR); ZBIGNIEW TOCZYLOWSKI, Clermont-Ferrand (FR); JAN SLOWINSKI, Clermont-Ferrand (FR); MICHAL BLEDZKI, Clermont-Ferrand (FR)

(21) Appl. No.: 18/870,899

(22) PCT Filed: May 11, 2023
(86) PCT No.: PCT/EP2023/062568

§ 371 Date: Dec. 2, 2024

(30) Foreign Application Priority Data
Jun. 2, 2022 (FR) 2205340

(51) Int. Cl. B65G 1/04; B25J 5/00; B60L 5/00; B60L 5/38; B65H 67/06

(52) U.S. Cl. CPC B65G 1/0492; B25J 5/007; B60L 5/005; B60L 5/38; B65H 67/06

(57) ABSTRACT

An autonomously mobile device (12) for loading bobbins (18) in a manufacturing facility (10) comprises a first autonomously mobile carriage (30) on which a robotic arm (32) for moving at least one bobbin is mounted, the first autonomously mobile carriage also comprising a control unit, autonomous movement means controlled by the control unit, and an electrical energy storage device, the autonomous movement means and the robotic arm being supplied with electrical energy by the electrical energy storage device of this first carriage (30), the first autonomously mobile carriage (30) also comprising means (40) for electrically recharging its electrical energy storage device by mechanical friction contacts or contactlessly by electromagnetic induction.

### TECHNICAL FIELD

The present invention relates to the automated loading of bobbins in a manufacturing facility.

More precisely, the invention relates to the automated loading of thread bobbins onto a feed rack for feeding a weaving machine.

### CONTEXT

Textile reinforcers are products which may, for example, form part of the composition of a tyre.

For the manufacture of these textile reinforcers, manufacturers use weaving machines fed by a large number of thread bobbins. Thus, several tens of bobbins to more than a hundred bobbins can feed a single weaving machine.

To feed a weaving machine, the bobbins are arranged on long racks comprising hundreds of locations for receiving bobbins.

Once empty, the bobbins must be replaced with full bobbins.

According to a first solution of the prior art, operators are tasked with manually replacing the empty bobbins with full bobbins. This solution is not optimal because these manual loading and unloading operations lengthen the cycle time of the weaving machine and they can be hard for the operators when the full bobbins weigh several tens of kilograms.

An automated solution of the prior art is described in document EP 3127660. In this document EP 3127660, robotic arms are used to unload the empty bobbins and replace them with full bobbins on the racks. Each robotic arm is mounted on a carriage which also carries a load of several full bobbins and a container intended to receive the empty bobbins. A first drawback is that each carriage is guided on rails which can hinder operators who have to access the racks. Specifically, even though the loading and unloading of the bobbins onto or from the racks is automated, the operators still have to access the racks to connect the end of one thread to the beginning of another thread. Another drawback is that it is necessary to provide a rail/carriage/robotic arm assembly for each aisle situated between racks, which requires a significant investment.

Document CN113291929 proposes a solution which has less impact on the accessibility of the racks and which allows movement between different aisles situated between different racks. According to this document CN113291929, a robotic arm and its load of full bobbins are placed on an autonomously mobile carriage. One drawback of the solution proposed in document CN113291929 is that the power and the speed of the robotic arm, and therefore its ability to quickly lift bobbins of large weight, must be limited so as not to have too great an impact on the autonomy of the autonomously mobile carriage. Specifically, in the solution proposed in document CN113291929, only the electric battery/batteries on board the autonomously mobile carriage makes/make it possible to power both the robotic arm and the autonomously mobile carriage.

The aim of the present invention is to overcome the drawbacks of the prior art.

### SUMMARY OF THE INVENTION

To this end, one subject of the invention is an autonomously mobile device for loading bobbins in a manufacturing facility, the autonomously mobile device comprising a first autonomously mobile carriage on which a robotic arm for moving at least one bobbin is mounted, the first autonomously mobile carriage also comprising a control unit, autonomous movement means controlled by the control unit, and an electrical energy storage device, the autonomous movement means and the robotic arm of the first autonomously mobile carriage being supplied with electrical energy by the electrical energy storage device of this first carriage.

According to the invention, the first autonomously mobile carriage also comprises means for electrically recharging its electrical energy storage device by mechanical friction contacts or contactlessly by electromagnetic induction.

Thanks to the means for electrically recharging by mechanical friction contacts or contactlessly by electromagnetic induction, the electrical energy storage device of the first autonomously mobile carriage can be recharged with electrical energy while said first carriage is in use. In particular, the electrical energy storage device of the first autonomously mobile carriage can be recharged with electrical energy while the robotic arm of this first carriage is in the process of moving a bobbin.

Advantageously, the means for electrically recharging by mechanical friction contacts or contactlessly by electromagnetic induction can also allow the electrical energy storage device of the first carriage to be recharged with electrical energy while this first carriage is in the process of moving.

Thanks to the means for electrically recharging by mechanical friction contacts or contactlessly by electromagnetic induction, it is possible to equip the first autonomously mobile carriage with a rapid and powerful robotic arm without penalizing the autonomy of this first autonomously mobile carriage.

For example, the robotic arm of the first autonomously mobile carriage is an arm with 6 degrees of mobility and/or makes it possible to move a load weighing up to 40 kilograms, and/or makes it possible to move a load of 40 kilograms at a speed which may range up to 4 m/s.

Advantageously, the autonomously mobile device comprises a second autonomously mobile carriage on which a bobbin supply rack is mounted, this second autonomously mobile carriage also comprising a control unit, autonomous movement means controlled by the control unit, and an electrical energy storage device, and the autonomous movement means of this second autonomously mobile carriage being supplied with electrical energy by the electrical energy storage device of this second carriage.

Preferably, the second autonomously mobile carriage also comprises means for electrically recharging its electrical energy storage device by mechanical friction contacts or contactlessly by electromagnetic induction. Thus, the electrical energy storage device of the second autonomously mobile carriage can be recharged with electrical energy while said second carriage is in use.

More generally, another subject of the invention is a manufacturing facility comprising at least one feed rack for feeding at least one machine of the manufacturing facility and at least one autonomously mobile device as has just been described.

According to the invention, the means for electrically recharging by mechanical friction contacts of the first carriage comprise an arm for electrical connection to an electrical supply rail provided in the manufacturing facility. With the manufacturing facility comprising at least one aisle on either side of which are located feed racks for feeding at least one machine of the manufacturing facility, at least one electrical supply rail is fastened to a feed rack in each aisle of the facility.

For example, with the manufacturing facility comprising at least one weaving machine, a feed rack makes it possible to receive bobbins for feeding threads to this weaving machine to manufacture a textile product from these threads.

For example, the textile product manufactured by the weaving machine is used for manufacturing a rubber product reinforced with this textile product.

For example, the reinforced rubber product is used for manufacturing pneumatic or airless tyres, caterpillar tracks or conveyor belts.

### DESCRIPTION OF THE DRAWINGS

Further features and advantages of the invention will become apparent from the following description. This description, given by way of non-limiting example, refers to the appended drawings, in which:

FIG. 1 is a top view of part of a manufacturing facility and of an autonomously mobile device for loading bobbins according to the invention,

FIG. 2 is a side view of part of a manufacturing facility and of an autonomously mobile device for loading bobbins according to the invention,

FIG. 3 is a perspective view of a first autonomously mobile carriage of an autonomously mobile device for loading bobbins according to the invention,

FIG. 4 is a side view of a first autonomously mobile carriage of an autonomously mobile device for loading bobbins according to the invention,

FIG. 5 is a diagram showing the relationships between the various components of a first autonomously mobile carriage of an autonomously mobile device for loading bobbins according to the invention,

FIG. 6 is a perspective view of a second autonomously mobile carriage of an autonomously mobile device for loading bobbins according to the invention,

FIG. 7 is a diagram showing the relationships between the various components of a second autonomously mobile carriage of an autonomously mobile device for loading bobbins according to the invention.

### DETAILED DESCRIPTION

The invention relates to the automated loading and unloading of bobbins in a manufacturing facility.

### Facility

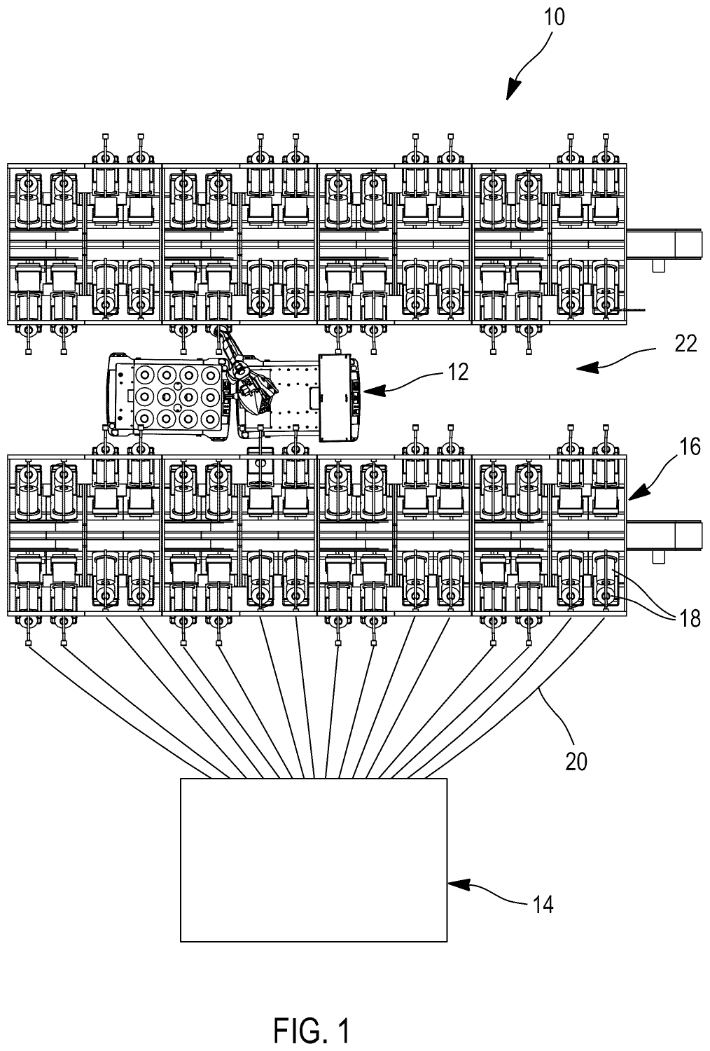

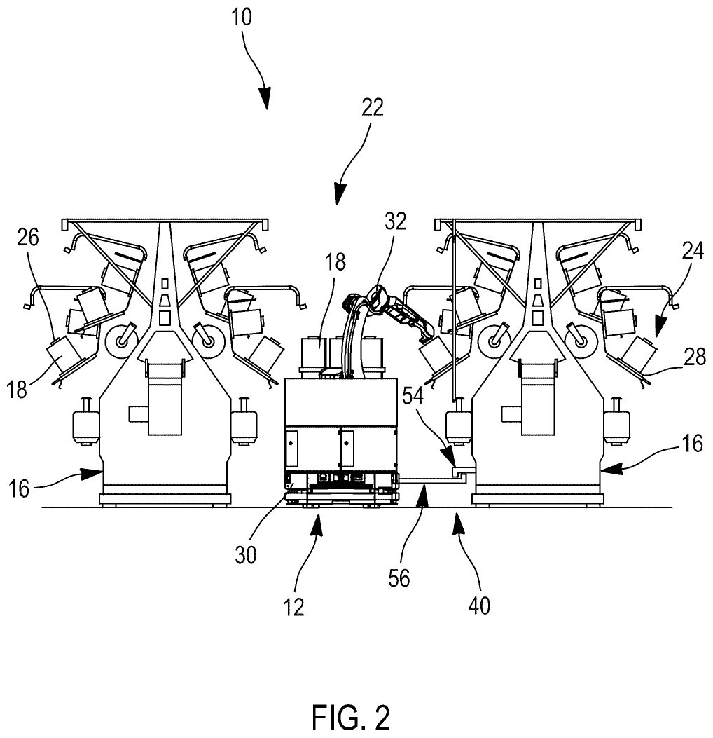

FIGS. 1 and 2 show part of a manufacturing facility 10 in which an autonomously mobile device 12 for loading bobbins according to the invention can be used.

For example, the manufacturing facility 10 comprises at least one weaving machine 14 and at least one feed rack 16 making it possible to receive bobbins 18 for feeding threads 20 to this weaving machine to manufacture a textile product from these threads. The threads 20 may be made from nylon or aramid, for example.

A bobbin 18 of thread 20 can weigh up to 12 kg.

For example, the textile product manufactured by the weaving machine 14 is used for manufacturing a rubber product reinforced with this textile product. For example, the reinforced rubber product is used for manufacturing pneumatic or airless tyres, caterpillar tracks or conveyor belts.

As shown in FIGS. 1 and 2, the manufacturing facility comprises at least one aisle 22 on either side of which are located feed racks 16 for at least one machine 14 of the manufacturing facility, for example a weaving machine.

### Autonomously Mobile Device for Loading Bobbins

For automated loading and unloading of bobbins, the manufacturing facility comprises at least one autonomously mobile device 12. This autonomously mobile device 12 moves autonomously in the manufacturing facility. More precisely, the autonomously mobile device 12 moves autonomously in an aisle 22 on either side of which are located feed racks 16.

Each rack 16 comprises a plurality of bobbin receiving devices 24. A bobbin receiving device 24 comprises at least one spindle 26 on which a bobbin 18 can be placed. A bobbin receiving device 24 comprises, for example, a support 28 comprising a plurality of bobbin receiving spindles 26. Preferably, the bobbin receiving spindles 26 are oriented towards the centre of an aisle 22 in order to facilitate the automated loading and unloading of bobbins by the autonomously mobile device 12 for loading bobbins.

### First Carriage

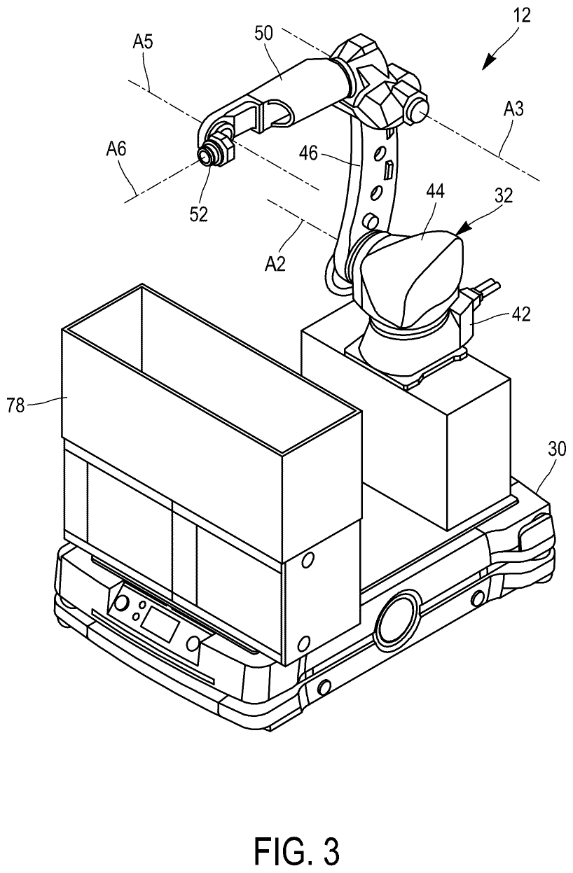

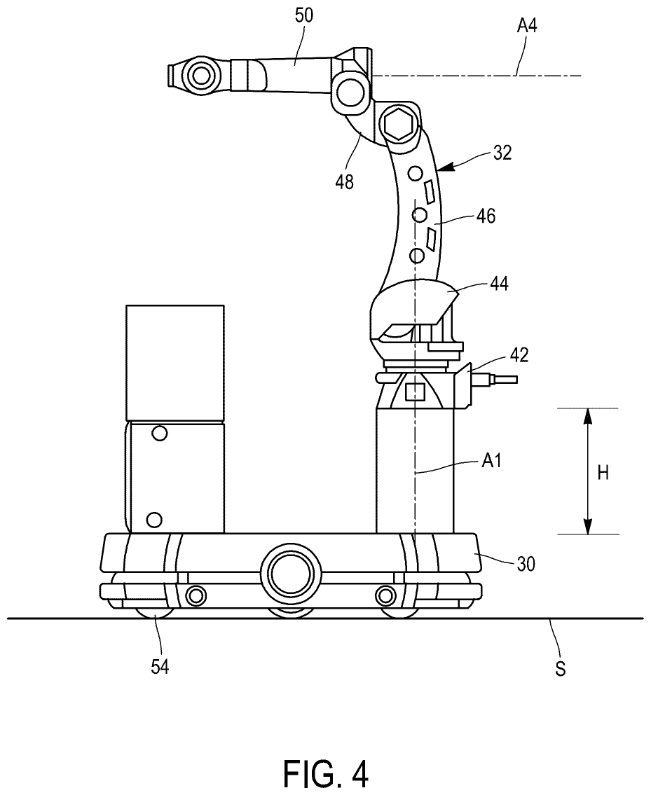

According to the invention and as shown in FIGS. 3 and 4, the autonomously mobile device 12 comprises a first autonomously mobile carriage 30 on which a robotic arm 32 for moving at least one bobbin 18 is mounted.

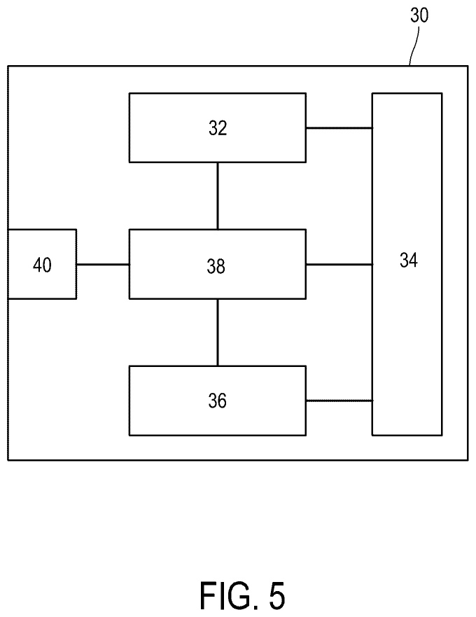

As illustrated schematically in FIG. 5, the first autonomously mobile carriage 30 also comprises a control unit 34, autonomous movement means 36 controlled by the control unit, and an electrical energy storage device 38.

The autonomous movement means 36 and the robotic arm 32 of the first autonomously mobile carriage 30 are supplied with electrical energy by the electrical energy storage device 38 of this first carriage 30.

The robotic arm 32 is, for example, controlled by the control unit 34, and the control unit 34 is, for example, supplied with electrical energy by the electrical energy storage device 38 of the first carriage 30.

The robotic arm 32 of the first carriage 30 is, for example, an arm with 6 degrees of mobility. Thus, the robotic arm 32 can access a large number of bobbin receiving devices 24 from the same location in an aisle 22. More precisely, the robotic arm 32 comprises, for example, a pedestal 42 fastened to the first carriage 30, a base 44 mounted so as to be rotatable with respect to this pedestal 42 about a first mobility axis A1, a lower arm 46 mounted so as to be rotatable with respect to the base 44 about a second mobility axis A2, an intermediate arm 48 mounted so as to be rotatable with respect to the lower arm 46 about a third mobility axis A3, an upper arm 50 mounted so as to be rotatable with respect to the intermediate arm 48 about a fourth mobility axis A4, and a gripping tool 52, for example for gripping a bobbin, mounted so as to be rotatable with respect to the upper arm 50 about two mobility axes A5, A6 perpendicular to each other.

Preferably, the robotic arm 32 of the first autonomously mobile carriage 30 makes it possible to move a load, and therefore a bobbin, for example, weighing up to 40 kilograms and/or makes it possible to move a load of 40 kilograms at a speed which may range up to 4 m/s.

Since the robotic arm 32 of the first autonomously mobile carriage 30 is supplied with electrical energy by the electrical energy storage device 38 of this first carriage 30, electric motors are used to set the robotic arm in motion. In more detail, different electric motors are used to rotate the arms 46, 48, 50 and the gripping tool 52 about their mobility axes.

Advantageously, the pedestal 42 of the robotic arm is raised by a non-zero height H above the first autonomously mobile carriage 30. Thus, the robotic arm 32 has a greater height working amplitude.

The autonomous movement means 36 of the first autonomously mobile carriage 30 allow this first carriage to move autonomously on the floor S of the manufacturing facility. In particular, the autonomous movement means 36 allow the first autonomously mobile carriage 30 to move autonomously in an aisle 22 of the manufacturing facility.

These autonomous movement means 36 comprise, for example, a plurality of wheels 54, at least one of these wheels being driven to rotate by an electric motor supplied with electrical energy by the electrical energy storage device 38 of the first carriage and controlled by the control unit 34 of the first carriage.

In parallel, the autonomous movement means 36 comprise, for example, at least one sensor allowing the control unit 34 to analyse the environment of the first carriage in order to effect the movements of the carriage in an environment such as a manufacturing facility 10.

The control unit 34 of the first carriage 30 comprises one or more processors and various memories.

The electrical energy storage device 38 of this first carriage 30 takes the form, for example, of one or more electrical batteries. For example, these batteries are of lithium type.

### Means for Electrically Recharging the First Carriage

According to the invention, the first autonomously mobile carriage 30 also comprises means 40 for electrically recharging its electrical energy storage device 38 by mechanical friction contacts or contactlessly by electromagnetic induction.

For example, these electrical recharging means 40 allow the electrical energy storage device 38 to be recharged with electrical energy during the use of the robotic arm 32 and/or of the first carriage 30.

For example, and as illustrated in FIG. 2, the means 40 for electrically recharging by 20 mechanical friction contacts of the first carriage 30 comprise an arm 56 for electrical connection to an electrical supply rail 54 provided in the manufacturing facility 10. For example, at least one electrical supply rail 54 is fastened to a feed rack 16 in each aisle of the facility. An electrical supply rail 54 may extend over several metres, and for example over the entire floor length of a feed rack 16, i.e. over the entire length of an aisle 22.

In the case where the electrical recharging means 40 operate contactlessly and by electromagnetic induction, a first electromagnetic induction device is, for example, integrated into the floor S of the facility, in particular in an aisle 22, and a second electromagnetic induction device is, for example, integrated into the first carriage 30. An electromagnetic induction device comprises, for example, one or more induction coils.

### Second Carriage

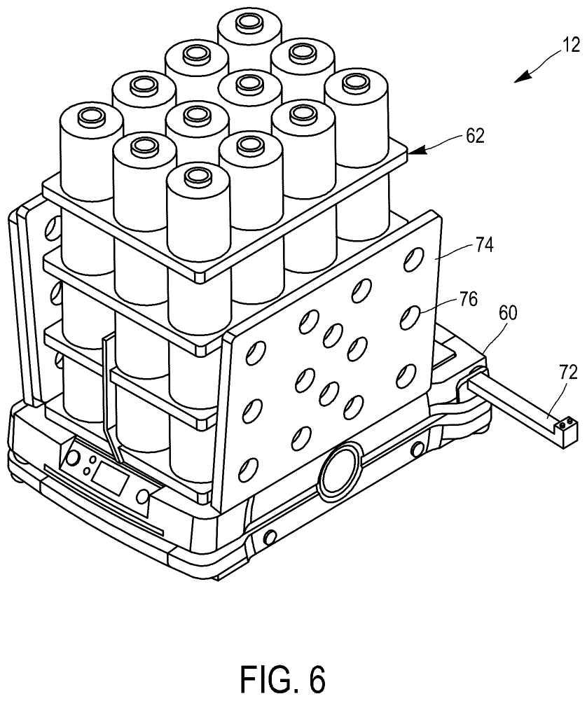

According to the invention and as shown in FIGS. 1 and 6, the autonomously mobile device 12 may also comprise a second autonomously mobile carriage 60 on which a rack 62 for supplying bobbins 18 is mounted. This second autonomously mobile carriage 60 makes it possible to supply the robotic arm 32 of the first carriage 30 with full bobbins 18.

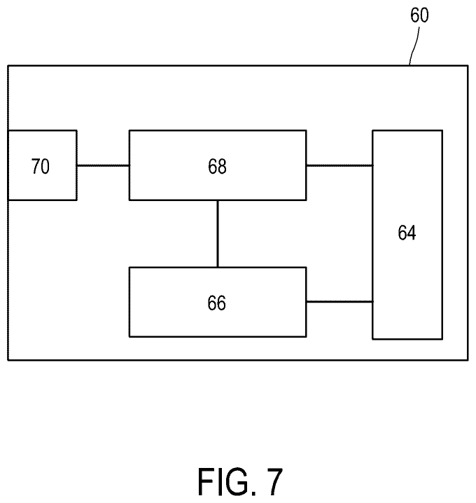

As illustrated schematically in FIG. 7, the second autonomously mobile carriage 60 also comprises a control unit 64, autonomous movement means 66 controlled by the control unit, and an electrical energy storage device 68. The autonomous movement means 66 are supplied with electrical energy by the electrical energy storage device 68 of this second carriage 60. The control unit 64 is, for example, supplied with electrical energy by the electrical energy storage device 68 of this second carriage 60.

According to the invention, the second autonomously mobile carriage 60 also comprises means 70 for electrically recharging its electrical energy storage device 68 by mechanical friction contacts or contactlessly by electromagnetic induction.

The autonomous movement means 66 of the second autonomously mobile carriage 60 allow this second carriage to move autonomously on the floor S of the manufacturing facility. In particular, the autonomous movement means 66 allow the second autonomously mobile carriage 60 to move autonomously in an aisle 22 of the manufacturing facility.

These autonomous movement means 66 comprise, for example, a plurality of wheels (not visible in FIG. 6), at least one of these wheels being driven to rotate by an electric motor supplied with electrical energy by the electrical energy storage device 68 of the second carriage and controlled by the control unit 64 of this second carriage.

In parallel, the autonomous movement means 66 comprise, for example, at least one sensor allowing the control unit 64 to analyse the environment of the second carriage 60 in order to effect the movements of the second carriage 60 in an environment such as a manufacturing facility 10.

The control unit 64 of the second carriage 60 comprises one or more processors and various memories.

The electrical energy storage device 68 of this second carriage 60 takes the form, for example, of one or more electrical batteries. For example, these batteries are of lithium type.

In order to allow its electrical energy storage device 68 to be recharged with electrical energy during its use, the second carriage 60 may comprise means 70 for electrically recharging by mechanical friction contacts or contactlessly by electromagnetic induction.

For example, the means 70 for electrically recharging by mechanical friction contacts of the second carriage 60 comprise an arm 72 for electrical connection to an electrical supply rail provided in the manufacturing facility 10, and for example to the electrical supply rail 54 used to supply the electrical recharging means 40 of the first carriage 30.

Alternatively, the electrical recharging means 70 of the second carriage 60 may operate contactlessly and by electromagnetic induction. In this case, a first electromagnetic induction device is, for example, integrated into the floor S of the facility, in particular in an aisle 22, and a second electromagnetic induction device is, for example, integrated into the second carriage 60. An electromagnetic induction device comprises, for example, one or more induction coils.

The rack 62 for supplying bobbins 18 of the second carriage 60 takes the form, for example, of plates 74 with holes 76 allowing nesting with the ends of the bobbins 18. Advantageously, these perforated plates 74 may be manipulated by the robotic arm 32 of the first carriage 30. Ideally, a plurality of perforated plates 74 may be stored on the second carriage 60 before being used for bobbin storage.

Advantageously, the first carriage 30 or the second carriage 60 comprises a receptacle 78 for receiving empty bobbins 18. Preferably, the first carriage 30 comprises this receptacle 78 for receiving empty bobbins.

### Method

The invention also relates to a bobbin loading method using the autonomously mobile device 12 in a manufacturing facility 10.

According to this bobbin loading method, the energy storage device 38 of the first carriage 30 is recharged with electrical energy via its means 40 for electrically recharging by mechanical friction contacts or contactlessly by electromagnetic induction while the robotic arm 32 loads a bobbin 18 onto a feed rack 16 for a machine 14 or unloads a bobbin 18 from a feed rack 16 for a machine 14. Advantageously, the method may also provide that the energy storage device 68 of the second carriage 60 is recharged with electrical energy via its means 70 for electrically recharging by mechanical friction contacts or contactlessly by electromagnetic induction while the robotic arm 32 takes a bobbin 18 from the supply rack 62 of the second carriage 60.

Still according to this bobbin loading method, the energy storage device 38 of the first carriage 30 may be recharged with electrical energy via its means 40 for electrically recharging by mechanical friction contacts or contactlessly by electromagnetic induction while the first carriage 30 is moving in the manufacturing facility. Advantageously, the method may also provide that the energy storage device 68 of the second carriage 60 is recharged with electrical energy via its means 70 for electrically recharging by mechanical friction contacts or contactlessly by electromagnetic induction while the second carriage 60 is moving in the manufacturing facility.

1.-10. (canceled)

11. An autonomously mobile device for loading bobbins in a manufacturing facility,
the autonomously mobile device comprising a first autonomously mobile carriage on which a robotic arm for moving at least one bobbin is mounted,
the first autonomously mobile carriage further comprising a control unit, autonomous movement means controlled by the control unit, and an electrical energy storage device,
the autonomous movement means and the robotic arm of the first autonomously mobile carriage being supplied with electrical energy by the electrical energy storage device of the first autonomously mobile carriage,
wherein the first autonomously mobile carriage further comprises means for electrically recharging the electrical energy storage device by mechanical friction contacts or contactlessly by electromagnetic induction.

12. The autonomously mobile device according to claim 11, wherein the autonomously mobile device comprises a second autonomously mobile carriage on which a bobbin supply rack is mounted, the second autonomously mobile carriage further comprising a control unit, autonomous movement means controlled by the control unit, and a second electrical energy storage device, and
wherein the autonomous movement means of the second autonomously mobile carriage is supplied with electrical energy by the second electrical energy storage device of the second autonomously mobile carriage.

13. The autonomously mobile device according to claim 12, wherein the second autonomously mobile carriage further comprises means for electrically recharging the second electrical energy storage device by mechanical friction contacts or contactlessly by electromagnetic induction.

14. A manufacturing facility comprising at least one feed rack for feeding at least one machine of the manufacturing facility, the manufacturing facility comprising at least one autonomously mobile device according to claim 11, and the means for electrical recharging by mechanical friction contacts of the first autonomously mobile carriage comprising an arm for electrical connection to an electrical supply rail provided in the manufacturing facility.

15. The manufacturing facility according to claim 14, wherein, with the manufacturing facility comprising at least one aisle on either side of which are located feed racks for feeding at least one machine of the manufacturing facility, at least one electrical supply rail is fastened to a feed rack in each aisle of the facility.

16. The manufacturing facility according to claim 14, wherein, with the manufacturing facility comprising at least one weaving machine, a feed rack enables the at least one weaving machine to receive bobbins for feeding threads to manufacture a textile product from the threads.

17. The manufacturing facility according to claim 16, wherein the textile product manufactured by the at least one weaving machine is used for manufacturing a rubber product reinforced with the textile product.

18. The manufacturing facility according to claim 17, wherein the reinforced rubber product is used for manufacturing pneumatic or airless tires, caterpillar tracks or conveyor belts.

19. A method for loading a bobbin in the manufacturing facility according to claim 14, wherein the energy storage device of the first autonomously mobile carriage is recharged with electrical energy via the means for electrical recharging by mechanical friction contacts or contactlessly by electromagnetic induction while the robotic arm loads a bobbin onto a feed rack for the at least one machine or unloads a bobbin from a feed rack for the at least one machine.

20. The method for loading a bobbin according to claim 19, wherein the electrical energy storage device of the first autonomously mobile carriage is recharged with electrical energy via the means for electrical recharging by mechanical friction contacts or contactlessly by electromagnetic induction while the first autonomously mobile carriage is moving in the manufacturing facility.
